(19) United States
(12) Patent Application Publication
(10) Pub. No.: US 2003/0149876 A1
(43) Pub. Date: Aug. 7, 2003

(54) Method and system for performing perfectly secure key exchange and authenticated messaging

(75) Inventor: Paul McGough, Centreville, VA (US)

Correspondence Address: MAYER, FORTKORT & WILLIAMS, PC, 251 NORTH AVENUE WEST, 2ND FLOOR, WESTFIELD, NJ, 07090, US

(73) Assignee: Secure Choice LLC

(21) Appl. No.: 10/062,312

(22) Filed: Feb. 1, 2002

(51) Int. Cl. H04L 9/00

(52) U.S. Cl. 713/171

(57) ABSTRACT

A system and method for the cryptographic exchange of information is provided which affords maximum security, process simplicity and participant convenience to any software application, business process or device used to communicate messages. The system provides the ability to openly exchange encryption keys for each communication between participants in a totally secure fashion. Along with the key exchange, the system and method can be used to secure all accompanying message content with a derived message key. The system and method derives the message key in such a manner that the original encryption key cannot positively be determined from a discovered message key. The system and method additionally provide a technique for authenticated exchange of new encryption keys such that the new key is completely dissimilar from any previous key, effectively eliminating any chained key knowledge.

### FIELD OF THE INVENTION

The present invention relates generally to systems and methods for performing perfectly secure encryption key exchanges in connection with an authenticated encrypted message, and more particularly to a system and method for participants in an electronic messaging platform to communicate new data encryption keys in a perfectly secure manner along with other information that is used to encrypt and authenticate a uniquely secured message through any communication avenue.

### BACKGROUND OF THE INVENTION

Conventional electronic messaging systems that use an encryption technique for security do not use any methods that provide absolute, provable security for a one-time key exchange that is combined and connected with an authenticated and uniquely encrypted message using this one-time session key. In order to perform these beneficial and related functions, one must currently use two distinct methods: (i) public key encryption (which is not provably secure) to perform the key exchange; and (ii) a secret key encryption technique to use that key to encrypt the message. Because these two systems are unrelated, so, too is the authentication. Along with the vulnerabilities and inherent difficulties introduced by the combination of these two unrelated systems (which vulnerabilities include man-in-the-middle attacks, performance issues in the electronic infrastructure, complexity of the applications to handle multiple techniques, and imperfect mathematics that is susceptible to methods other than brute force and ever increasing computational speeds), the unacceptable disadvantage of these combined techniques is that the user of these systems is made to perform complex and unnatural behavioral modifications. As a result, the user frequently fails to follow these techniques correctly, thus compromising the security of the system and diminishing its value.

There thus remains a need in the art for a single, related system that delivers singular key use to uniquely protect message data while combining a simple, perfect exchange of that singular key. In particular, there is a need in the art for a system and method to combine authenticated message encryption and perfectly secure key exchange into a single asymmetric transmission between messaging participants.

There is also a need in the art for a system and method that, while combing these two necessary steps into one, can relate one key to the next such that the key chain never delivers a definitive formation even if an unintended party learns the identity of a particular key in the chain.

There is also a need in the art for a system and method that uses the perfectly secure exchanged key to encrypt an accompanying language-based message, such that there is provably only one manner in which to determine the contents, which is to attempt all of the possible key combinations (i.e., a brute force attack).

There is also a need in the art for a perfectly secure key exchange using this methodology such that the chained key relationship is re-started in a manner that is indecipherable even when a key exchange message is known to be sent.

These and other needs are met by the present invention, as hereinafter described.

### SUMMARY OF THE INVENTION

In one aspect, the present invention relates to systems and methods for the perfectly secure exchange of numeric encryption keys, provided a shared numeric secret already exists between exchange participants, and for the authenticated encryption of any accompanying message content.

According to one aspect of the present invention, a single linear equation is used at least two, and initially three times, in succession to exchange new keys as undecipherable derivations of the existing shared secret, and a straight-forward process, using one of the undecipherable key derivations, is then used to encrypt any additional information bundled as the message content.

In accordance with an exemplary embodiment, a shared numeric secret exists between messaging participants. The shared secret is a string of characters, and preferably is a number of either decimal or hexadecimal content, such as “1234” or “3D5F”. This original shared secret, called the Existing Secret (ES), is preferably distributed in secret prior to the use of this embodiment using a suitable distribution method (e.g., through phone, email, mail, physical exchange, or by being embedded in a device). If the ES is not of sufficient length, as determined by the current length definition of the time period of use, then this system provides for a Trusted Exchange (TE) of a new proper length ES with only the knowledge of the current ES required by the participants.

This exemplary embodiment may be understood with reference to a system in which there are two message participants, hereinafter termed “Alice” and “Bob”, along with a third, unauthorized participant “Eve”, who has no knowledge of the ES. The system will allow Alice or Bob to send a message to the other that is indecipherable to Eve, and in so doing, exchange new keys by deriving the new keys from the ES using a simple linear formula and a straight-forward process. The derived new keys include one to be the new Existing Secret for the next future message and another to be the unique Message Key (MK) to be used to encrypt this message's accompanying content.

In another aspect, the present invention relates to a system and method of the type described above for the provision of secret messaging between two participants who are unknown to one another, but are known to a specific contact point in the system in which both participants are communicating. In accordance with the system and method, each participant is connected to the system with an ES prior-secret relationship, and while they are unknown to one another, they communicate in secret as previously described above with their known contact point which then communicates also as described above with other known contact points until reaching the contact point that knows the intended recipient. This contact point is then also communicated with as described above, and he finally communicates with the end-recipient. Thus, for example, if Alice wants to communicate with Bob, whom she does not have an ES prior-secret relationship, but she does have such a relationship with Point A in the network, and if she knows that Bob is at least also on the network, then she communicates in secret as described above with Point A, whom she instructs to find Bob. For example, Point A might “know” (i.e., have an ES prior-secret relationship) Point B, which knows Point C, which knows Point D, which knows Bob. Hence, Alice can communicate with Bob indirectly by utilizing this chain of existing ES prior-secret relationships. In so doing, each Point in the chain communicates Alice's message to the next Point in the chain using ES prior-secret relationships, until finally Point D communicates the message to Bob, with whom it has an existing ES prior-relationship.

In still another aspect, the present invention relates to a system and method of the type described above wherein, after a unique MK is created and exchanged, the system will encrypt the accompanying content using a variable portion, up to and including the entirety, of this unique MK in a manner that includes one of two different key expansion techniques, and at least one, and preferably two, different transposition processes.

In still another aspect, the present invention relates to a system and method of the type described above which is used only for communicating as a key exchange system to generate the next future message's new ES and the unique MK. Instead of using this method's encryption technique for the accompanying message content, another system is used to encrypt the accompanying message content. In some embodiments of this aspect of the invention, a predetermined accompanying content will be used to exchange a new ES for the next future message.

In another aspect, the present invention relates to a method for exchanging secure messages between two parties, comprising the steps of receiving a first sequence of characters, operating on the first sequence with a first algorithm at least twice in succession, thereby forming second and third sequences of characters, encrypting a message through the use of at least one of the second and third sequences, thereby forming an encrypted message, and sending the encrypted message, and preferably the second and third sequences, to a recipient.

In a further aspect, the present invention relates to a method for exchanging secure messages between three parties based on a first existing sequence of characters known to a first and second party and a second existing sequence, distinct from the first existing sequence, which is known to the second and third party. The method comprises the steps of generating a first encrypted message through the use of a first encryption key derived from the first sequence of characters, generating a second encrypted message from the first encrypted message through the use of a second encryption key derived from the second sequence of characters, and decrypting the second encrypted message through the use of a third encryption key derived from the second sequence of characters.

In another aspect, the present invention relates to a method for exchanging secure messages between two parties based on an existing sequence of characters, comprising the steps of operating on the existing sequence with a first algorithm at least two times, thereby forming first and second sequences of characters, encrypting a first message such that it can be decrypted using the first sequence, thereby forming a first encrypted message, and sending the first encrypted message and the second sequence to a recipient, wherein the recipient operates on the second sequence with the first algorithm to generate third and fourth sequences of characters.

In a further aspect, the present invention relates to a method for exchanging secure messages between two parties, comprising the steps of receiving an original sequence of characters; operating on the original sequence three consecutive times with a first equation, thereby forming first, second and third sequences of characters, respectively; operating on one of the first, second and third sequences with a second equation, thereby creating a fourth sequence of characters; and encrypting a message through the use of the fourth sequence of characters.

In still another aspect, the present invention relates to a method for exchanging encryption keys, comprising the steps of receiving from a sender a first message encrypted through the use of a first encryption key; decrypting the first message through the use of the first encryption key; operating on the first encryption key with an equation so as to produce a second encryption key; encrypting a second message through the use of the second encryption key, thereby creating a second encrypted message; and communicating the second encrypted message and the second encryption key to the sender.

In another aspect, the present invention relates to a method for exchanging encryption keys, comprising the steps of (a) providing an encryption key defined as a first sequence of characters; (b) operating on the key with a first equation so as to produce at least a second and third sequence of characters; (c) encrypting a message through the use of at least one of said second and third sequences of characters, thereby creating a first encrypted message; (d) communicating the first encrypted message and the second and third sequences of characters to a recipient; (e) redefining the encryption key as said second sequence of characters; and repeating steps (a) through (e) at least once.

In a further aspect, the present invention relates to a method for exchanging message keys between two parties based on an sequence of characters known to the parties, comprising the steps of operating on the existing sequence of characters with a first equation at least two times, thereby forming a first and second sequence of characters; creating a message containing first and second parts, wherein the first part of the message comprises the first and second sequence of characters, and wherein the second part of the message comprises a message text; encrypting the message, thereby forming a first encrypted message; and sending the first encrypted message to a recipient.

In another aspect, the present invention relates to a software program or set of programs which are disposed in a tangible medium, and which contain instructions suitable to carry out any of the above noted methods, or any portions thereof.

In yet another aspect, the present invention relates to a system adapted to carry out any of the above noted methods, or any portions thereof.

These and other aspects of the present invention are described in greater detail below.

### BRIEF DESCRIPTION OF THE DRAWINGS

FIG. 1 is a flowchart illustrating an embodiment of the methodology of the present invention.

FIG. 2 is a flowchart illustrating an embodiment of the methodology of the present invention.

FIG. 3 is a flowchart illustrating an embodiment of the methodology of the present invention.

FIG. 4 is a flowchart illustrating an embodiment of the methodology of the present invention.

### DETAILED DESCRIPTION

As used herein, the term ‘perfectly secure’, when used in reference to a key exchange, means that there is no way to derive the keys used in the exchange other than through a brute force algorithm (which, logically, is always available).

As used herein, the term ‘provable security’ means that the mathematics of the exchange dictate that the only solution available is the intended one.

In accordance with the present invention, a perfectly secure key exchange and authenticated messaging system and methodology is provided for encryption key distribution, management and message protection. The system and methodology overcome a number of infirmities in existing systems that are designed for secure messaging. For convenience, the system of the present invention will frequently be referred to as the Krypt eXchange Protocol (KXP), and components or portions of systems and methodologies in accordance with the present invention may be referred to by similar or derivative names, it being understood that the present invention is not limited in any way by any products or services that may be sold or marketed under that name or designation, either now or in the future.

The system of the present invention will typically include software components, which may be written in multiple programming languages for operation on a variety of computer operating systems or platforms. Hardware components may also be provided that may be built to facilitate the use and deployment of the system and methodology of the present invention in multiple electronic devices.

In the preferred embodiment of the system of the present invention, a set of software referred to as a KXP Toolkit is used to provide a security layer to other software applications, business processes or electronic devices. This security layer acts to secure communications between the user of the device, application or process and another user or an owner of the content within the device, application or process. The KXP Toolkit preferably requires that all communicating participants have a single, original Existing Shared Secret that is in a Base 10 or Base 16 number format and preferably of at least 10-digits or characters in length. These numbers can be represented in either a “macro” format, such as an account number, or in electronic format in a minimum of 4-bits each, such that the minimum recommended number of bits for the Existing Shared Secret (ES) is 40-bits.

These ES numbers will preferably have been initially distributed to each participant outside the scope of the KXP using existing distribution and registration processes such as exists for the initial distribution of a credit card and its ES, which is typically the account number. Along with the ES, an OpenID number or character string is provided that associates any secure communication to the ES and owning participant. If desired, the format of such OpenID can be application, device or process dependent. As explained in greater detail below, the KXP process allows for the secure exchange of future encryption keys based on existing encryption keys or an ES, even if the existing encryption keys or ES has been compromised. Hence, additional security can be imparted to the system by requiring that the first communication between parties, prior to the exchange of any substantive message, is a key exchange to establish a new ES that can be used in the exchange of the first substantive message. Additional security can also be imparted to the system by requiring periodic or random key exchanges between parties, even if the parties are not actively exchanging substantive messages, since this makes derivation of any particular key set by a third party significantly more resource intensive.

In order to understand the KXP as a process for key exchange and encryption, a few system fundamentals (functions or primitives) of one particular embodiment of the system are provided:

System Primitives (Functions)

1. KXPE (Krypt eXchange Protocol Equation)

(x+y) Mod baseX=7 where x and y are baseX numbers (X being any integer value, normally 10 or 16), either single digits or individual digits of a larger number

2. LKES (Limited Knowns Equation Set)

(a+7) Mod baseX=b

(b+c) Mod baseX=9

where a, b and c are single digits (or individual digits of a larger number) of any baseX

3. OWC (One-Way Cut)

Contracts a number by adding paired digits using the KXPE; the selection spacing can be any Separation Value (SV) such that all the numbers are paired and used only once.

(a(1)+a(2)) Mod baseX and (a(3)+a(4)) Mod baseX, and . . . and (a(n−1)+a(n)) Mod baseX for a result of b(1, 2, 3, 4 . . . n).

4. NEK (Never Ending Key)

Expands a number by modulus baseX adding digit pairs determined by the offset of the digit values themselves, then using an increasing pointer on the offset, then using one of the pointer cycles as the new expansion number, resulting in a continuous, non-repeating number stream with final size determined by use.

a. Using a pointer begun at digit position one that cyclically moves to the right one digit for each calculation, take the value of the number digit at the pointer, and modulus baseX add the digit value at the position found to the right (offset) where the ‘zero position’ is the first one to the right, ‘position one’ is the second to the right, etc. (circling back around the digit if this moves “off the end” of the number)

b. The resulting value is the next NEK digit in the stream. When the pointer has moved through all of the digit positions, add one position to the selection criterion for the ‘value to the right’ or offset (e.g., instead of selecting the digit position for the mod add found by the pointer's position value that many offset digits, use the offset plus one)

i. This method, Increment Method 1 (IM1), is to increment selection after the offset; a second method, Increment Method 2 (IM2), can be to increment the offset selection while beginning at the same position—either works equally ‘randomly’; e.g., the equation sets for the final values are still KXPE unsolvable, and the distribution as the number expands is still position oriented, not mathematically oriented

c. When this cycle pointer has generated all of the mod adds in each cycle (adding one to the cycle pointer for each sequence) and it is now greater than the original length of the original number, replace the original number with the digit sequence that resulted when the cycle pointer value is equal to the digit value in position one of the original number

d. Continue through this new number for all of the cycles, and then replace it in the same manner, continuing ‘forever’

NEK(a(1, 2, 3, 4))=b(1, 2, 3, 4, 5, 6, 7, 8, 9, . . . )

For example, NEK(1234)=(1+3) and (2+1) and (3+3) and (4+1) and (1+4) and (2+2) and (3+4) and (4+2) and . . . continuing until the cycle pointer is greater than 4, and then replacing 1234 with 5476 (which is the number generated from the first number's cycle “1”, from the first digit) and beginning again with (5+7) and (4+7) and . . . all Mod 10 until the desired length is reached for 43655476 . . . 21 . . . end

An example:

NEK(a)=27163904882901 . . . Begins with these possibilities (decimal example):

| | |
|---|---|
| 02_{— — — — — — — — —} . . . | These 10 possibilities all result in the “2” |
| | from the |
| 1_1_{— — — — — — — —} . . . | stream. And then to meet the “7”, one can |
| | place a |
| 2_{— —}0_{— — — — — — —} . . . | 07 in digit positions two and three in eight of |
| | these |
| 3_{— — —}9_{— — — — — —} . . . | possibilities, a 1_6 can fit into seven of |
| | them, a |
| 4_{— — — —}8_{— — — — —} . . . | 2_{— —}5 can fit into six, etc. |
| 5_{— — — — —}7_{— — — —} . . . | The end result? The choices quickly become |
| 6_{— — — — — —}6_{— — —} . . . | overwhelming and never positively correct. |
| 7_{— — — — — — —}5_{— —} . . . | |
| 8_{— — — — — — — —}4_ . . . | |
| 9_{— — — — — — — — —}3 . . . | |

e. The NEK may be further complicated by keeping secret the length of the original number, as there is no identifiable division in the expansion stream of any cycle start or end

f. For a NEK of a specific length, the function may be complicated even more by selecting the index of where to start within the original number, and the value of the pointer; the cycle can also be chosen with some additional calculations required to realize the seed number—the seeds need to be generated in sequence to arrive at the correct one first.

5. PK (Position Key)

Expands a number using the NEK function, except it uses a second number as the offset instead of the number itself. The first number to be expanded is called the Value Key (VK), and the second number is the Offset Key (OK)

PK(c([c(1), a(1)] and [c(2), a(2)] and [c(3), a(3)] and . . . ))=b(1,2,3,4,5,6,7,8,9 . . . )

6. ML (Matrix Lookup)

Use two index numbers to return two positions in a Matrix Lookup, and then KXPE sum those for a single result.

Example: Using the following hexadecimal matrix

| | | | |
|---|---|---|---|
| P(0) = 3 | P(4) = 7 | P(8) = 9 | P(C) = 1 |
| P(1) = 1 | P(5) = 3 | P(9) = 3 | P(D) = B |
| P(2) = 4 | P(6) = A | P(A) = D | P(E) = 0 |
| P(3) = 9 | P(7) = 2 | P(B) = 2 | P(F) = 8 |

and the KXPE formula where (P(i1)+P(i2)) Mod 16=7, can one determine (positively) i1 and i2?

The ML varies per square, with the number of possibilities varying for any particular summed result. The numbers cannot positively be identified, because there are multiple possibilities for both numbers. For example, when i1=0, then i1=2, but also i1 could equal E when i2=4. Each square must be totally known, along with the KXPE result, in order to calculate the ML for every available set of i1 and i2 possibilities, of which there will be multiple pairs equaling the same KXPE result.

### EXAMPLE 1

### The KXP System in Principle (Logic)

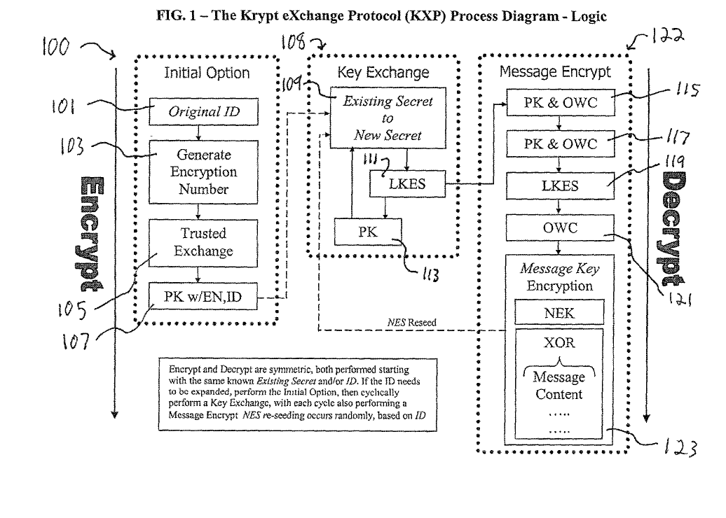

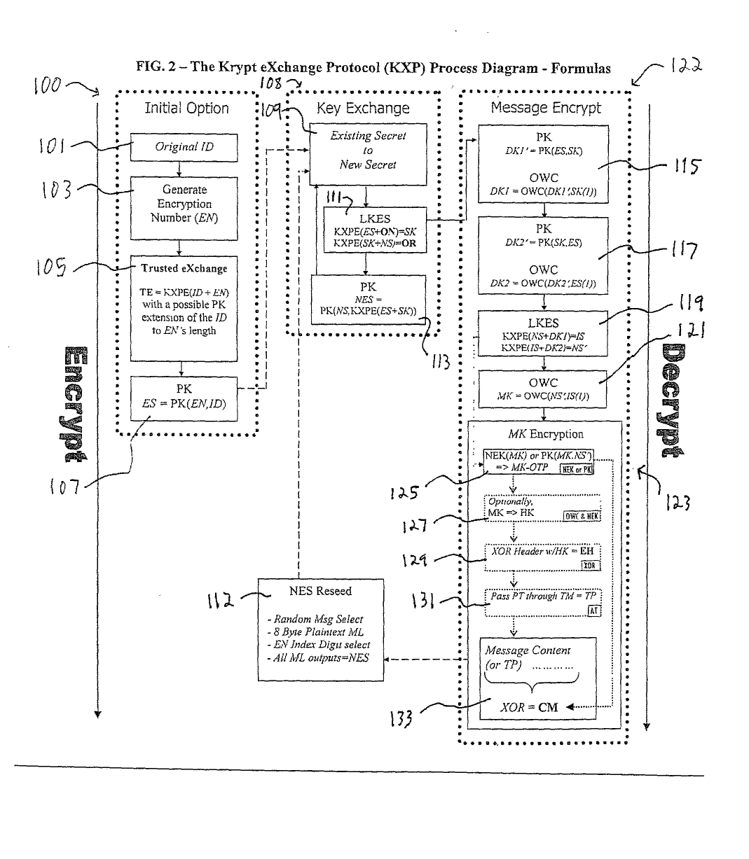

The following exemplary embodiment of the KXP illustrates the logic process of the system. FIGS. 1-2 illustrate this process schematically.

1. Begin (100) with an Existing Shared Numeric Secret (ID) (101) between a participant and a receiver

A. If the ID is too small to be effective alone, and/or if it needs to be absolutely protected, then perform a Trusted Exchange (105) which generates the initial Existing Secret starting point for secure messaging based on an Encryption Number (EN) (103).

i. LKES(ID, Encryption Number)=TE open, authenticated exchange (e.g., trusted—if not authenticated, system simply doesn't work, but is not broken)

ii. PK(ID, EN)=Initial Existing Secret (ES) (107)

2. For each and every secret communication, asymmetrically sent between the participant and the receiver originating from either one, perform the following key exchange, maintenance and encryption process (108):

A. Perform a Key Exchange of a New Existing Secret (NES) to be used in place of the last Existing Secret (109):

i. Perform LKES(ES, OpenNumber) new, indeterminate key material (111) Seed Key (SK), New Secret (NS) and includes an OpenReturn for receiver decryption (NES Reseed if necessary (112))

ii. NES=PK(NS, LKES (ES,SK)) (113)

B. Create a unique Message Key (MK) to be used as the base key for the message content

i. Data Key 1 (DK1)=OWC(PK(ES, SK)) (115)

ii. Data Key 2 (DK2)=OWC(PK(SK, ES)) (117)

iii. Unique, one-time onlyMK=OWC(LKES(NS,DKI,DK2)), (119, 121) resulting in an MK that is ½ the length of the ES

C. Encrypt the message (122) content with the MK (123), which authenticates and provides integrity and continuity, using either a known cipher, or a Practical One Time Pad (P_OTP) technique (125):

i. Without requiring transmission, create an MK_P_OTP of full byte key characters using a NEK(MK), and optionally an Alphabet Transposition (AT) that is rotated by cyclic MK key digits as offsets for any key re-use collision, only if MK_OTP expansion is performance-driven to be shorter than the plaintext

a. AT is exchanged in a message Encrypted Header (EH) by performing an XOR with the Header Key (HK) (129), which is created by NEK(OWC(MK))

ii. Ciphertext=Optionally, Plaintext (PT) sent through AT (131) to generate Transposed Text (TT), and then either the TT or the PT in an XOR (133) with the MK_P_OTP

D. Asymmetrically send the OpenNumber, OpenReturn, optional EH and the Ciphertext to the recipient

3. Decryption is a simple replication of the process based on the recipient having perfect knowledge of the ES or ID and the open outputs. Both participants will store the new ES (NES) for the next message.

4. Cyclically, the NES can be re-seeded using message content, from a sequentially selected message using a specified digit of the KXPE(EN, First ES) result

A. Use two other specified digits of that result to determine the message content starting point for the reseed

B. Place the content in 4-bit hex number representation blocks into a Matrix Lookup (ML) of 16 positions, such that 64-bits of message content makeup one ML

C. Use sequential digits of the KXPE(EN, First ES) result (or just the EN) as pointers into the ML, selecting two position values out of each ML

D. Perform KXPE(ML_Return1,ML_Return2) to generate a single new NES key digit

E. Repeat the ML selection using the next 64-bit block, pointers and function results until the required length NES is returned—in this NES creation, the ML content can be considered as known, yet the reseeded NES will be secure

### CONCLUSION

The KXP has delivered a secure, authenticated key exchange, secure communications that even if discovered retains the sanctity of the original secret, and a capability to communicate new secrets at will. The KXP system provides all of this, in a performance-enhancing single asymmetric transmission. The system uses provable, efficient and simple mathematics and cryptographic techniques to accomplish all of its goals without introducing any new participant requirements or “expert knowledge”. The KXP is a compact, single transmission system that is performance enhanced by the simple formulas and is future computing-assured with known, well-identified attacks and remedies.

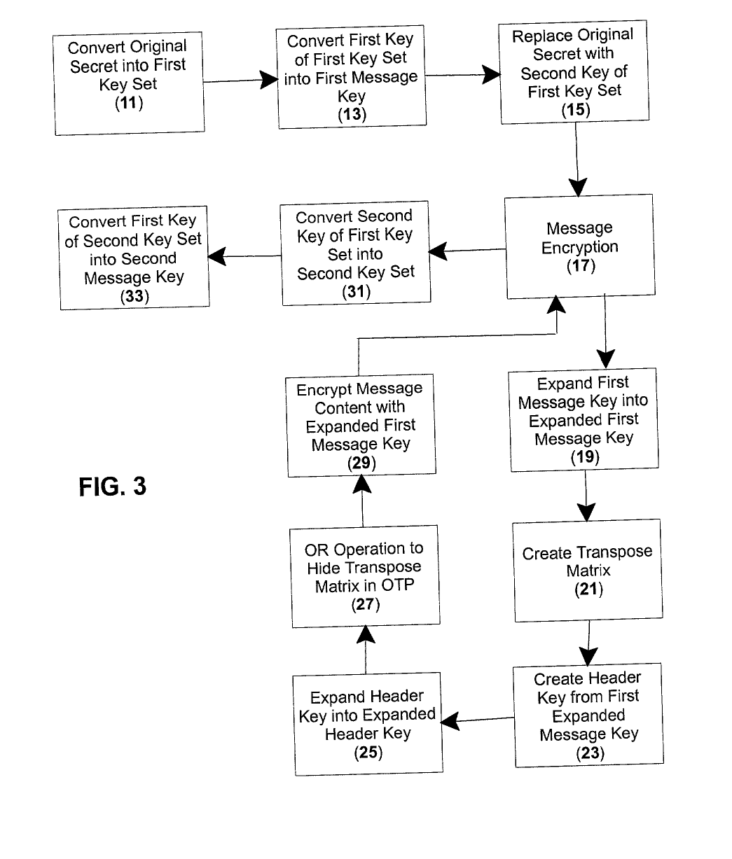

The present invention can be further understood with reference to the flowchart of FIG. 3, which illustrates one non-limiting example of a system having some of the features described above. After an Original Secret has been established, it is converted 11 into a first key set by a user. A first key of the first key set is then converted 13 into a first message key. The Original Secret is replaced 15 by a second key taken from the first key set. Message encryption 17 is then accomplished by expanding 19 the first message key into an expanded first message key, creating 21 a transpose matrix, creating 23 a header key from the first expanded message key, expanding 25 the header key into an expanded header key, using the expanded message key in an OR operation to hide 27 the transpose matrix in an OTP, and encrypting 29 the message content with an expanded first message key. A second key of the first key set is then converted 31 into a second key set, and a first key of the second key set is converted 33 into a second message key.

### EXAMPLE 2

The following example illustrates some of the details of one particular embodiment of the KXP Process. In this example, it is assumed that Alice and Bob know secret A, which is a number with an even number of digits that is at least 10 digits in length.

Encryption:

The following encryption scheme is used:

1. Start with an already distributed shared secret; an existing shared numeric key (Existing Secret ES) and perform the Initial Option, if required

Numerous systems exist with this criterion—credit cards, personal devices, etc.

In order to use these already distributed shared secrets, when one wishes to ‘join’ a KXP cloud (key store), there is/will be a registration process

The ES will be composed of numbers represented in 4-bits of up to a hexadecimal number, with a time-period defined n-bit (X hex numbers) minimum; this may be, for example, 256-bits (64 hex numbers)

If the existing number is too short in length (or only decimal) to be used as an encryption key and the registration process cannot or will not handle the distribution of a proper length new ES (the Preferred Strategy for initial ES setup), then perform the Initial Option which includes a Trusted Exchange (TE) procedure to lengthen the short ES for initial use:

Preferred Strategy—distribute an out-of-band n-bit Existing Secret ES equal to four times the digit length of the required Message Key (MK) where MK will be time-period computationally implausible. Split this ES into two halves, using the first half as the ID throughout the KXP, and the second half as the EN. Both of these halves are exponentially larger than the MK, and therefore a brute force is ‘impossible’ (as measured in practical key space searching). This should be no more systematically difficult than PKI certificate distribution, or original Credit Card distribution systems; and like those systems, it only has to be done once.

Initial Option—

Use an Existing Secret ES that is already distributed or embedded in a device (ESN or IMEI in a cell phone, a Credit Card number, Account Number, etc.) of at least 10 digits (hex preferably, but decimal is acceptable)

Register this number, if not already, with the system connection point in the KXP cloud (this device's/person's key store) in an out-of-band manner and associate a key store CustomerliD (CID) that will be used within the key store to identify this KXP participant and retrieve the proper key sequence for any secret messaging

At the registration point, have the device (or user) randomly generate a number (called the Encryption Number—EN) whose digit length is twice the required MK length (this brings the number to an even number of digits, which is the useable length of any KXP key whether the short ID is comprised of an odd number of digits or not)

Exchange (out-of-band, or openly either manually or through the device) the KXPE sum of the ES and the extended number (EN) with the key store KXPE(ID+EN) using Mod 16 as the EN is always hex

This exchange is called the Trusted Exchange (TE) in that it is not imperative that the TE result be kept secret, but it must be authenticated. If it is captured and held, it is acceptable in that a KXPE output does not lend itself to any input decipherment. And it is also acceptable if the result is tampered with during the exchange—because if it is, the participant will not be able to ever send a message correctly (nothing is stolen, but also the KXP will not work; so this is simply a nuisance interference, not a security violation).

It is quite possible that the Original ID doesn't have enough length to sufficiently produce enough TE output without having to recycle itself. When this is the case, in order to begin creating the TE digit immediately after the KXPE sum of the existing ID and EN numbers, expand the ID to an ID-Full:

Use a ‘modified’ PK where the start of the VK is the first EN digit and the VK length is the EN up to the matching length of the ID; use the ID as the OK

As each PK digit is created, then concatenate it to the ID (creating ID-Full) and KXPE add it to the corresponding digit of the EN

Extend the VK, and move the selection pointer one digit, as each digit of the PK is created

For example:

ID=1234abcd where abed will need to be the extended digits

EN=07293861 TE=1953 to start

a=0+2=2 where the “0” is digit one of the VK (currently 0729),

and the OK is “1” from the ID

b=7+3=0 where the “7” is digit two of the VK (currently 07293), and the OK is “2” from the ID

c=2+0=2 where the “2” is digit three of the VK (currently 072938, and the OK is “3” from the ID and we need to cycle back

around the VK to use the 0

d=9+7=6 where the “9” is digit four of the VK (currently 07293861), and the OK is “4” from the ID and we need to cycle back around the VK to use the 7

ID-Full is then 12342026, and the full TE, exchanged in a trusted manner, is then 19535887

Now to create the first, initial Existing Secret (ES), perform a PK with the full length ID-Full as the VK and the EN as the OK ES=PK(ID-Full, EN)

2. Perform secure Key Exchange

Create a key set of three unknown keys using an LKES (and two knowns)—Existing Secret (ES), Seed Key (SK) and New Secret (NS) and Open Number (ON) and Open Return (OR)

(ES+ON) Mod baseX=SK

(SK+NS) Mod baseX=OR where the NS is randomly generated

PK (Positional Key) function using the Value Key (VK)=NS, Offset Key (OK)=KXPE(ES+SK), the result is the new (or next) ES, the NES

PK(NS, KXPE(ES+SK))

Randomly, the NES chain will be reseeded by performing a NES Reseed (NES-R)

NES Reseed (NES-R)

The KXP exchanges new keys (ES and MK) for every message and authenticates that exchange with content encryption. But it is also possible to ‘break’ the NES exchange (and chain) by deciphering one through brute-force or a guess (even though at an exponentially greater than already improbable MK key space)

Therefore, it is beneficial to reseed the NES chain at random intervals (from an opponents perspective) such that even after a small series (or just one) of NES keys, the chain would be reset such that the entire new series would begin again at NES and MK key spaces (a broken NES leads to a trivially broken MK, but a broken MK does not trivially lead to the NES chain—this requires exponentially greater effort, equivalent to the brute force of the ES to start)

Using the plaintext message content of the chosen random message as a salt value in the reseeding process does this. This is cryptographically thought to be a weak process, but immediately this danger can be dispelled because the plaintext of the message will be treated as if it were a known value. It will not be, due to the randomness of the selection, but the assumption will be that this is the case, removing the regular danger of using already transmitted information as key values.

The NES-R process:

Use a digit of the Original ID to determine which out of the 10 or 16 (the base of the ID will determine this) will be the next random NES-R message for this process. Keeping a message count (by both sender and receiver) is relatively simple, and when Count Mod ID_Digit is 0, then the NES will be formed by this NES-R process instead of the LKES/PK usual technique. The system format for the selection of the NES-R frequency can be changeable, as by moving through the ID digits for the message selection criteria in order, or using the digits themselves to move within the ID and then selecting that digit to determine the message; or it can be static for all participants, or may utilize a static digit, such that there is a pattern, but it is individual for each participant (knowledge by an opponent that a particular sequence is being used is irrelevant, just as it is which message is actually selected: it is preferred to make this another difficult step for an opponent, but it is alright if it is not)

When within the count, and a participant knows that this message is a NES-R message, then begin the plaintext selection by using the next two digits in the ID as the starting point within the message for the first byte in the NES-R. (In total, using a hex ID, this is 16*256=4096 possible starting points in the chain to begin byte selection)

Using each byte to represent 2 hex numbers (4-bits each), select 8 byte blocks in succession to fill a Matrix Lookup (ML) square in position order from P(0) through P(15). In total, in order to reseed the entire NES, one will need to use (2*#-of-bits-in-NES) bytes. If the message does not have that many, then start at byte one instead of the offset selection. If still not enough, cycle around and re-use the bytes (remember—these are treated as a known value already, so this is not an information leak)

Use a modified ML index selection in that, instead of using two Index Digits to return a single sum, simply use one Index Digit to return the value in the ML position matching the Index Digit; the Index Digit comes from using the EN digits in cyclic fashion beginning with the first (or system defined start—which can be ‘randomized’ using digits from the ID as the selection criterion as already shown)

Repeat ML fill using the next 8 byte block, return the Index Digits choice, and cyclically repeat until enough digits are returned to equal the NES length

The NES will be formed simply by concatenating all of these ML returns together

The security of this reseeded NES is that, first, it must be broken again at that exponentially great key space, since even knowing the message, the start point, and what the ML makeup is, does not help. This is because the EN is totally unknown (and irrefutably hidden in the original KXPE in the TE), so it is impossible to tell which digit is returned. If one does know the exact ML makeup (the system should be setup so this is not known), since all the MLs will not contain all numbers, one can limit the possibilities for the NES digits (e.g., if there are only 9 out of 16 digits represented in an ML, then that position of the NES will only have that probability). This still requires one to break the NES, but it is possible to decrease, only marginally, the key space to search; it will, with normal distributions of plaintext, still be exponentially larger than a MK search, but possibly less than a full NES search. If one does successfully break this new NES chain again, one still cannot positively configure the EN, as there will be multiple ML squares with multiple digits. Consequently, one would have to repeat this NES break multiple times and still never limit the NES totally.

Should some KXP implementations require assurance that this cyclic brute force of multiple ‘impossible’ key spaces does not occur, a ‘regular’ ML Index Digit setup may be used of two digits returning a sum out of the ML (which has as much repetitive possibilities as single digit returns), and where the two digits are formed by summing the EN digits into pairs (where 4 EN digits are required to return a single ML output). This would require cycling through the EN four times to return enough NES digits. However, even if one does the previous multiple NES breaking and mapping, one is left with digit pairs that cannot ever be positively identified (KXPE logic applies) (with respect to ID digit uses, it should be noted that, if one wishes to be certain that none of these ID digit uses will be traceable such that the ID could be exposed, then one can simply use digit sums as the single digits for selection; e.g., one can use a OWC (KXPE(ID)) such that the original ID digits can never be determined].

3. Perform Message Encryption

Create a unique, one-time only Message Key (MK) to encrypt the content of this message

PK function using VK=ES, OK=SK, returning a result that is twice the ES length; this result is called DK1′ (Increment Method (IM) determined by odd (IM1—select then increment) or even (IM2—increment select) of the OK)

DK1′=PK(ES, SK)

OWC (DK1′,[SV]) using an optional Separation Value (SV) with this result called DK1

DK1=OWC(DK1′,[SV could be SK(1)])

This OWC function is performed by:

Start on digit one of the DK1′

Modulus baseX add digit one with the digit offset to the right that many spaces defined by the SV, where one digit to the right is SV=0

Perform this paired sum in cycle, moving one digit to the right in the DK1′ result using the next available, non-used (not yet summed) number until all numbers have been paired such that the DK1 key is ½ the length of its VK

Should the SV not evenly divide into all of the digits, such that there are left over digits not yet paired (and that cannot be summed using the SV), then these digits are simply adjacently KXPE summed

PK function using VK=SK, OK=ES, returning a result that is twice the ES length; this result is called DK2′

DK2′=PK(SK, ES)

OWC(DK2′) with the result called DK2

DK2=OWC(DK2′)

LKES using the NS and DK1 and DK2

(NS+DK1) Mod baseX=Interim Solution (IS)

(IS+DK2) Mod baseX=NS′

OWC(NS′) with the result being the Message Key (MK)

MK=OWC(NS)

In order to encrypt the message content uniquely with the MK, any acceptable cipher can be used here, or the KXP method may be used:

Use the NEK function, with index (₁St digit), pointer (2^{nd} digit) and cycle parameters (3^{rd} and 4^{th} digits), to expand the MK such that it becomes a One Time Pad (OTP) key of at least the message length (MK-OTP) where the NEK digits are paired to create a byte key character for each byte of the message content (e.g., the NEK must expand the MK to return twice the message byte-length number of digits)

Optionally, use the PK function for this expansion, where the VK is the MK and the OK is an OWC(MK w/SV=0, which is adjacent digits)

Use an XOR and/or a one-time Alphabet Transposition (AT) to encrypt the message content with the MK-OTP. The AT, if used, is simply a matrix that re-arranges the 256 electronic ASCII characters such that, for example, ASCII 001 would be 213, 046 would be 134, etc. This one-time transposition order can be rotated by cyclic MK key digits as offsets if the MK_OTP expansion is performance-driven to be shorter than the plaintext, and where there would then be key re-use collisions. For instance, if MK digit 1 is “5”, then ASCII 001 would now be 218, 046 would be 139, etc.; then for the third rotation and MK key re-use, if MK digit 2 is “B” (11 in decimal), then ASCII 001 would be 229, etc.

If an AT is used, or if any other information needs to be exchanged for this message such as useable (out of available) Value Key lengths, then create a Header Key (HK) to uniquely XOR encrypt it

Determine the length of the Header (256 bytes for the alphabet order, n bytes for the VK lengths, n bits for the index, pointer and cycle parameters)—order and format of the Header is system defined

OWC function the original MK, using MK(1) as the SV, and NEK expand the result to the required just defined length creating a Header Key (HK) (or optionally PK expand using the original MK as the OK)

XOR encrypt the Header with the HK; the result is the Encrypted Header (EH)

Pass the plaintext (PT) through the Transpose Matrix (TM) resulting in Transposed Plaintext (TP)

XOR encrypt the TP, if created, or the PT using the MK-OTP, resulting in the Ciphertext Message (CM)

4. Identify the message with a unique, random open MessageID (MID) for audit and control purposes

Preferably, this is a 16-digit, hexadecimal number, as that is a large enough key space to uniquely identify messages in any large system

The MID can also be sequential, if required

5. Identify the message with an open CustomerID (CID) that uniquely identifies which original or last shared secret to use to open this message

Format system defined (determined during initial registration, or using a system preformatted one such as a telephone number, birth date, etc.)

6. Send the Total Open Message (MID, CID, ON, OR, [EH], CM) asymmetrically in either direction by any participant who has knowledge of the pre-shared ES or last NES

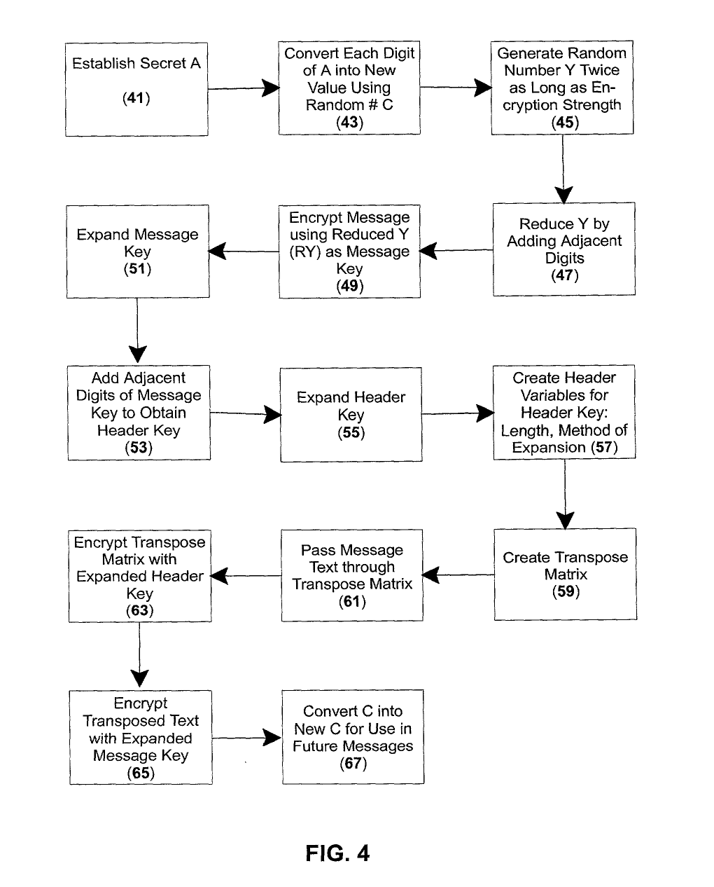

Various encryption algorithms may be used in the practice of the present invention. One such algorithm is depicted in FIG. 4. As shown therein, the process assumes that a secret A has been established 41 between two parties, and that this secret comprises a plurality of digits. Each digit of A is then converted 43 into a new value, as through application of a modular arithmetic equation using a random number C. Next, a random number Y is generated 45 which is twice as long as the required encryption strength. This number is then reduced 47 by half through modular addition of adjacent digits. The reduced Y is then used as the message key to encrypt 49 a language-based message.

After message encryption, the message key is expanded 51, and a header key is obtained by adding 53 adjacent digits of the message key. The header key is then expanded 55, and header variables are created 57 which may indicate, for example, the technique or techniques used to expand the header key, the length of the message key, and the length of the One Time Pad, if one was used in the encryption.

Next, a transpose matrix is created 59, and the message text is passed 61 through the transpose matrix. The transpose matrix is then encrypted 63 with the expanded header key, and the transposed text is encrypted 65 with the expanded message key. Finally, C is converted 67 into a new C for use in encrypting future messages, as through the transposition of certain digits in C and/or the exchange of digits in C with numbers generated by various formulas.

Decryption:

1. Use the CID to lookup the appropriate Shared Secret (Existing Secret ES) for this sender—this might/might not be done by the final destination participant, but regardless, the decrypt process is identical throughout the KXP ‘cloud’

2. Then use the ES and the open ON and OR to decrypt the content and store the New Existing Secret

Recreate the LKES and MK using the open values, and the starting shared secret, to create the unknowns

Decrypt the message contents—unsuccessful decryption means unauthenticated, tampered message, or ‘lost key’ message (sent with a key not in recipient's chain)

Create the New Existing Secret using the LKES key material

Store the NES as did the Sender, and per system requirements

### EXAMPLE 3

The following example demonstrates some of the calculations and processes that may be used in a particular embodiment of the KXP process constructed in accordance with the present invention. No Header mode is included in this example, e.g., there is no Alphabet Transposition.

Initial Option

| | |
|---|---|
| Original ID = 0372 | (decimal) |
| EN = 0B372A65 | (hex) |

```
TE = 0EA9D5B2 from 0 + 0 = 0 3 + B = E 7 + 3 = A 2 + 7 = 9 and
                  (0,0 = B) + 2 = D (B,3 = B) + A = 5 (3,7 = 5) + 6 = B
                  (7,2 = D) + 5 = 2
```

| | | |
|---|---|---|
| Initial ES = 3E941BD175 | from | PK(0372BB26, 0B372A65) where (0,0 = 3) + 0 = 3 |
| (3,B = B) + 3 = E | . . . | 9^{th} ES digit is (0,0 + 1 offset = 7) + 0 =7 |

10^{th} ES digit is (3,B + 1 offset = 2) + 3 = 5
Key Exchange
LKES KXPE(ES + ON) = SK KXPE(SK + NS) = OR

| | | |
|---|---|---|
| ES | 3E941BD175 | |
| ON | B302CC178C | Known |
| SK | E196D8E8F1 | (3 + B), (E + 3) . . . |
| NS | 7F39A51826 | Generated |
| OR | 50CF7DF017 | Known = (E + 7), (1 + F) . . . |

| NES | PK(NS, KXPE(ES + SK)) |
|---|---|
| | PK(7F39A51826, (3E941BD175 + E196D8E8F1)) |
| | PK(7F39A51826, 1F2AE3B966) |
| | (7,1 = 3) + 7 = A (F,F = 8) + F = 7 . . . |
| | A7830B3077 |

Message Encrypt

| DK1′ | PK(ES, SK) |
|---|---|
| | PK(3E941BD175, E196D8E8F1) using Increment Method 2 (IM2) as SK(1) is |

even

(3,E = B) + 3 = E (E,1 = 4) + E = 2 . . . 11^{th} digit (3,(E + 1 position) = 1) = 9) +

3 = C 12^{th} digit (E,9 = E) + E = C

E2278CBE83CCE55E85A8

DK1 = OWC(DK1′) using a Separation Value of 0 (adjacent digits) in all OWCs

| | OWC(E2278CBE83CCE55E85A8) |
|---|---|
| | (E + 2) (2 + 7) . . . |
| | 0949B833D2 |
| DK2′ | PK(SK, ES) |
| | PK(E196D8E8F1, 3E941BD175) using Increment Method 1 (IM1) as SK(1) is |

odd

(E,3 = D) + E = B (1,E = E) + 1 = F . . . 11^{th} digit ((E,3) = D + 1 position = 8) + E =
6 12^{th} digit ((1,E) = E + 1P = 8) + 1 = 9
BF25B0C9D969F757F67F

DK2 = OWC(DK2′)

OWC(BF25B0C9D969F757F67F)
(B + F) (2 + 5) . . .
A7B56F6C56

LKES KXPE(NS + DK1) = IS KXPE(IS + DK2) = NS′

| | |
|---|---|
| NS | 7F39A51826 |
| DK1 | 0949B833D2 |
| IS | 78725D4BF8 |
| DK2 | A7B56F6C56 |
| NS′ | 1F27BCA74E |

| MK | OWC(NS′) |
|---|---|
| | OWC(1F27BCA74E) |
| | (1 + F) (2 + 7) . . . |
| | 09712 |

Could use any cipher technique here with the MK. The KXP cipher:
Message Hello World!
48 65 6C 6C 6F 20 57 6F 72 6C 64 21

| | |
|---|---|
| MK-OTP | NEK(MK) |
| | NEK(09712) to return 24 values (using IM1, MK(1) being odd) |
| | (0,0 = 9) + 0 = 9 (9,9 = 9) + 9 = 2 (7,7 = 0) + 7 = 7 |
| | (1,1 = 0) + 1 = 1 (2,2 = 7) + 2 = 9 (0,0 = 9 + 1P = |
| 7) + 0 = 7 | (9,9 = 9 + 1P = 7) + 9 = 0 . . . |
| | 92719700A31AE842B8220993 |
| | 92 71 97 00 A3 1A E8 42 B8 22 09 93 to use as ASCII key |

characters
Ciphertext Message XOR MK-OTP
48 65 6C 6C 6F 20 57 6F 72 6C 64 21 XOR 92 71 97 00 A3 1A E8 42 B8 22 09
93

DA14FB6C CC3ABF2DCA4E6DB2

Although various embodiments are specifically illustrated and described herein, it will be appreciated that modifications and variations of the present invention can be made on the basis of the above teachings and are within the purview of the appended claims without departing from the spirit and intended scope of the invention.

What is claimed is:

1. A method for communicating securely, comprising:
converting an original secret into a first key set comprising a first plurality of keys;
converting a first key of the first key set into a first message key through the use of a first linear and digit-position-based one-way function;
replacing the original secret with a second key of the first key set; and
using the second key of the first key set as a first new secret for a subsequent communication.

2. The method according to claim 1, further comprising encrypting message content using the first message key.

3. The method according to claim 2 wherein, after the first message key is used to encrypt message exactly content once, the new secret is converted into a second key set comprising a second plurality of keys.

4. The method according to claim 3, wherein a first key of the second key set is converted into a second message key by using a second linear and digit-position-based one-way function.

5. The method of claim 4, wherein the first and second functions are the same.

6. The method of claim 4, wherein the first new secret is replaced with a second of the second plurality of keys, thereby defining a second new secret for use in the next communication.

7. The method according to claim 2, wherein the first message key is used to encrypt the message content by
(a) first expanding the first message key into a first expanded message key comprising paired numbers, wherein each pair of numbers represents a byte of information, and
(b) using the first expanded message key to encrypt the message content.

8. The method according to claim 7, further comprising:
creating a transpose matrix;
creating a header key unique from the first expanded message key by operating on the first expanded message key with the first function;
expanding the header key into an expanded header key; and
using the header key in an XOR operation with a unique alphabet order such that the transpose matrix is hidden in a one time pad.

9. The method according to claim 8, further comprising the steps of:
passing plaintext of the message content through the transpose matrix, thereby creating transposed plaintext; and
performing an XOR operation with the transposed plaintext and the expanded message key to create a transposed and keyed ciphertext.

10. The method according to claim 1, wherein the original secret comprises a number with an even number of digits that is at least ten digits in length.

11. The method according to claim 1, wherein the original secret comprises a number with an even number of digits that is at least twenty digits in length.

12. The method according to claim 1, wherein the step of converting the original secret into the first key set includes performing a sequence of a plurality of linear operations on each digit of the original secret.

13. The method according to claim 1, wherein the step of converting the original secret results in a first key set which can only be uniquely determined with knowledge of the original secret.

14. The method according to claim 1, wherein the first key set includes at least three keys.

15. The method according to claim 8, wherein the step of expanding the message key is performed by one of a plurality of selectable techniques, and wherein the message includes a header which identifies the particular technique used.

16. The method according to claim 15, wherein the header also indicates the number of digits of the first message key that are used to encrypt the message content.

17. The method according to claim 15, wherein the header also includes how many digits are in the one time pad key.

18. The method according to claim 8, wherein the step of expanding the first message key includes the step of creating a one time pad key that is unknown, has no repetitive formation and is as long as the message content.

19. The method according to claim 18, wherein the one time pad key is formed by using cyclic linear modulus arithmetic of position values and their corresponding pointer values within a same number, and wherein a new number is chosen by taking a cycle of values created by a position offset of the first digit's value.

20. The method according to claim 7, wherein the byte of information comprises one of 256 bytes used in electronic content communication.

21. The method according to claim 8, wherein the expanded header key has at least enough digits in length so that each pair of digits can represent one of 256 bytes of an electronic alphabet.

22. A method for encrypting a message, comprising:
establishing secret A, which is a number with an even number of digits that is at least 10 digits in length;
converting each digit Aₖ of secret A into another value Aₙ through the use of the following formulas:
(Aₖ+a)Mod q=Bₖ; and
(Bₖ+Cₖ)Mod q=A;
wherein q is hexadecimal or decimal, the two formulas use each single corresponding digits of A, B, and C, and C is randomly created by the sender;
generating a random number Y which is twice as long as a system required message encryption strength;
cutting the random number Y in half through the modular addition of adjacent digits;
using the reduced random number as a message key to encrypt a language-based message;
expanding the message key;
cutting the expanded message key in half through the modular addition of adjacent digits to create Header Key;
expanding the header key;
adding a header including variables to indicate which of a plurality of techniques was used to expand the header key, the length of the message key and, if a one time pad was used, the length of the one time pad;
building a random, one-time transpose matrix of ASCII elements;
passing a plaintext message through transpose matrix to create a transposed plaintext;
encrypting the transpose matrix using the extended header key in an exclusive OR operation to create an encrypted header output;
encrypting the transposed plaintext using the extended message key in an exclusive OR operation to create a ciphertext output; and
converting C for a subsequent message by transposing the digits in C with a digit-position-based one-way function to create a converted C, and then using the converted C as a next A in a subsequent communication.

23. The method of claim 22, wherein the message further includes a transmitter ID which identifies the transmitter.

24. The method of claim 23, wherein the message further includes a message ID that uniquely identifies the message.

25. The method of claim 24, wherein the message is transmitted in the following sequence: transmitter ID, message ID, first key, second key, extended header, and cipher text.

26. The method of claim 22, wherein the message key is expanded using a one time pad expansion.

27. A method for encrypting a message, comprising:
establishing secret A, which is a number with an even number of digits that is at least 10 digits in length;
converting each digit Aₖ of secret A into another value Aₙ through the use of the following formulas:
(Aₖ+a)Mod q=Bₖ; and
(Bₖ+Cₖ)Mod q=Aₙ
wherein q is hexadecimal or decimal, the two formulas use each single corresponding digits of A, B, and C, and C is randomly created by the sender;
generating a random number Y which is twice as long as a system required message encryption strength;
cutting the random number Y in half through the modular addition of adjacent digits;
using the reduced random number as a message key to encrypt a language-based message;
expanding the message key;
cutting the expanded message key in half through the modular addition of adjacent digits to create a header key;
expanding the header key;
adding a header including variables to indicate which of a plurality of techniques was used to expand the header key, the length of the message key and, if a one timepPad was used, the length of the one time pad;
building a random, one-time transpose matrix of ASCII elements;
passing a plaintext message through transpose matrix to create a transposed plaintext;
encrypting the transpose matrix using the extended header key in an exclusive OR operation to create an encrypted header output;
encrypting the transposed plaintext using the extended message key in an exclusive OR operation to create a ciphertext output; and
converting C for a subsequent message by transposing C's digits by a digit-position-based one-way function and then using the converted C value as a next A in a subsequent communication.

28. The method of claim 27, wherein the message further includes a transmitter ID which identifies the transmitter.

29. The method of claim 28, wherein the message further includes a message ID that uniquely identifies the message.

30. The method of claim 29, further comprising the step of expanding the header.

31. The method of claim 30, wherein the message includes first and second keys, and wherein the message is transmitted in the sequence transmitter ID, message ID, first key, second key, expanded header, and cipher text.

32. The method of claim 30, wherein the message key is expanded using a one time pad expansion.

33. A method, applicable to a system for exchanging secure communications based on an existing secret wherein each communication within the system contains a message identification number, for randomly and indecipherably exchanging a new secret upon demand to be used to replace an existing secret, the method comprising:
providing a first number and a message identification number;
providing an operator that is a function of first and second variables;
providing a matrix lookup function which, on the basis of at least one given input number, uniquely determines a set of indices, and returns the element of a matrix defined by those indices;
operating on the first number and the message identification number with the operator to generate a second number;
generating first and second index numbers by applying the matrix lookup function to first and second digits, respectively, selected from the second number;
operating on the sum of the two index numbers with the operator, thereby generating a result; and
replacing the existing secret with the result.

34. The method of claim 33, wherein the operator is a modular arithmetic equation.

35. The method of claim 33, wherein the message identification number is taken from the most recently exchanged message.

36. The method of claim 33, wherein the matrix lookup function returns, on the basis of the input of digits m and n, the element (m, n) of an M×N matrix, wherein mε{1, . . . , M} and
nε{1, . . . , N}.

37. The method of claim 36, wherein the first digit selected from the second number is m, wherein the second digit selected from the second number is n, wherein the first index number is element (m, n) of the matrix, and wherein the second index number is element (n, m) of the matrix.

38. The method according to claim 33, wherein the message identification number comprises an openly exchanged, random number.

39. The method according to claim 38, wherein the random number comprises a 16-digit hexadecimal number.
